(19) United States
(12) Patent Application Publication
(10) Pub. No.: US 2020/0217108 A1
(43) Pub. Date: Jul. 9, 2020

(54) VEHICLE

(71) Applicant: Toyota Jidosha Kabushiki Kaisha, Toyota-shi (JP)

(72) Inventor: Shigeki Kinomura, Toyota-shi (JP)

(21) Appl. No.: 16/736,087

(22) Filed: Jan. 7, 2020

(30) Foreign Application Priority Data
Jan. 8, 2019 (JP) 2019-001156

(51) Int. Cl. E05B 81/74; B60L 50/60; B60L 1/00; E05B 81/62

(52) U.S. Cl. CPC E05B 81/74; B60L 50/60; E05B 81/77; E05B 81/62; B60L 1/00

(57) ABSTRACT

A lock relay switches supply and interruption of operating power for operating a door lock device to bring a door for vehicle occupant into a locked state. A lid lock device receives, through the lock relay, electric power for operating the lid lock device to bring a lid into a locked state. A connector lock device receives, through the lock relay, electric power for operating the connector lock device to bring connection between an inlet and a connector into a locked state.

### CROSS REFERENCE TO RELATED APPLICATIONS

This nonprovisional application claims priority to Japanese Patent Application No. 2019-001156 filed on Jan. 8, 2019 with the Japan Patent Office, the entire contents of which are hereby incorporated by reference.

### BACKGROUND

### Field

The present disclosure relates to a vehicle, and particularly to a vehicle configured to allow execution of external charging for charging a power storage device mounted in the vehicle by a charging facility provided external to the vehicle.

### Description of the Background Art

As to a vehicle including: a door lock device capable of switching a closed door for vehicle occupant between a locked state and an unlocked state; and a lid lock device capable of switching a closed lid between a locked state and an unlocked state. Japanese Patent Laying-Open No. 2014-159673 discloses a lock control system that controls a lid lock to be done in cooperation with a door lock. In this lock control system, in order to improve the convenience for vehicle users, the lid lock is switched to a locked state after a lapse of a prescribed time period since the door lock has been switched to a locked state.

Furthermore, Japanese Patent Laying-Open No. 2009-81917 discloses that a connector lock and a cover lock (a lid lock) are done in cooperation with a door lock in a vehicle further including a connector lock device capable of switching, between a locked state and an unlocked state, a connection between a connector of a charging cable used for external charging and a power receiving inlet of the vehicle.

However, the above-mentioned Japanese Patent Laying-Open No. 2014-159673 fails to specifically disclose a circuit configuration for operating each of a door lock device and a lid lock device. The above-mentioned Japanese Patent Laying-Open No. 2009-81917 also fails to specifically disclose a circuit configuration for operating each of a door lock device, a lid lock device, and a connector lock device.

### SUMMARY

An object of the present disclosure is to inexpensively form a circuit for operating each of a door lock device, a lid lock device, and a connector lock device in a vehicle configured to allow execution of external charging.

A vehicle according to the present disclosure is a vehicle that allows execution of external charging. The vehicle includes: a power receiving inlet, a lid, a door lock device, a lid lock device, a connector lock device, and a relay. To the power receiving inlet, a connector of a charging facility is connectable for external charging. The lid is provided at the power receiving inlet. The door lock device switches a door for vehicle occupant, between a locked state and an unlocked state. The lid lock device switches the lid between a locked state and an unlocked state. The connector lock device switches connection of the connector to the power receiving inlet between a locked state and an unlocked state. The relay switches supply and interruption of operating power for operating the door lock device to bring the door for vehicle occupant into the locked state. The lid lock device receives, through the relay, operating power for operating the lid lock device to bring the lid into the locked state. The connector lock device receives, through the relay, operating power for operating the connector lock device to bring the connection of the connector to the power receiving inlet into the locked state.

According to the above-described configuration, the lid lock device and the connector lock device can be operated in cooperation with the door lock device while the same relay can be used for switching supply and interruption of the operating power to each of the above-mentioned lock devices. Thus, according to the above-mentioned vehicle, each of the lock devices does not have to include a relay for switching supply and interruption of the operating power. Accordingly, a circuit for operating each lock device can be formed inexpensively.

When the relay is switched to be conductive, at least one of the lid lock device and the connector lock device may operate behind the door lock device by a prescribed time period.

When the lid lock device and the connector lock device operate simultaneously with the door lock device, the operation noises of die lid lock device and the connector lock device are masked by the operation noise of the door lock device. This may prevent a user from recognizing that die lid lock device and the connector lock device have operated. According to the above-described configuration, at least one of the lid lock device and the connector lock device operates behind the door lock device by prescribed time period, thereby allowing the user to recognize that the lid lock device and/or the connector lock device have/has operated,

When the relay is switched to be conductive, at least one of the lid lock device and the connector lock device may operate longer in time than the door lock device.

According to the above-described configuration, there occurs a situation where only at least one of the lid lock device and the connector lock device operates, which allows the user to recognize that the lid lock device and/or the connector lock device have/has operated.

The vehicle may further include a noise generator that generates a noise in accordance with an operation of at least one of the lid lock device and the connector lock device.

According to the above-described configuration, the noise generator allows the user to recognize that at least one of the lid lock device and the connector lock device has operated.

The vehicle may further include a controller that outputs a non-operation command to the lid lock device when the connector is connected to the power receiving inlet.

When the connector is connected to the power receiving inlet, the lid is opened, which eliminates the need to operate the lid, lock device. According to the above-described configuration, the lid lock, device is not operated when the connector is connected to the power receiving inlet. Thus, unnecessary consumption of electric power in the lid lock device can be prevented.

The vehicle may further include a controller that outputs a non-operation command to the connector lock device when the lid is closed.

When the lid is closed, the connector is not connected to the power receiving inlet, which eliminates the need to operate the connector lock device. According to the above-described configuration, the connector lock device is not operated when the lid is closed. Thus, unnecessary consumption of electric power in the connector lock device can be prevented.

The foregoing and other objects, features, aspects and advantages of the present disclosure, will become, more apparent from the following detailed description of the present disclosure when taken in conjunction with the accompanying drawings.

### BRIEF DESCRIPTION OF THE DRAWINGS

FIG. 1 is a diagram schematically showing an entire configuration example of a vehicle according to the first embodiment of the present disclosure.

FIG. 2 is a diagram showing a configuration example of a power receiving port unit.

FIG. 3 is a diagram showing a configuration example of a circuit the operating a door lock device, a lid lock device, and a connector lock device.

FIG. 4 is a diagram schematically showing a configuration example of the door lock device.

FIG. 5 is a flowchart illustrating an example of the procedure of a process performed in response to a user's door lock operation.

FIG. 6 is a diagram schematically showing a configuration example of a lid lock device in the second embodiment.

FIG. 7 is a diagram showing timings at which a door lock device, the list lock device, and a connector lock device in the second embodiment are operated.

FIG. 8 is a diagram showing timings at which a door lock device, a lid lock device, and a connector lock device in a modification are operated.

FIG. 9 is a diagram schematically showing an entire configuration example of a vehicle according to the third embodiment.

FIG. 10 is a flowchart illustrating an example of the procedure of a process performed in response to a user's door lock operation in the third embodiment.

FIG. 11 is a diagram showing a configuration example of a circuit for operating a door lock device, a lid lock device, and a connector lock device in the fourth embodiment.

FIG. 12 is a diagram schematically showing a configuration example of a lid lock device in the fourth embodiment.

FIG. 13 is a flowchart illustrating an example of the procedure of a process performed in response to the user's door lock operation in the fourth embodiment.

### DETAILED DESCRIPTION

Embodiments of the present disclosure will be hereinafter described in detail with reference to the accompanying drawings. Although a plurality of embodiments will be hereinafter described, it has been originally intended to combine the configurations described in each embodiment as appropriate. In the accompanying drawings, the same or corresponding components will be designated by the same reference characters, and the description thereof will not be repeated.

### First Embodiment

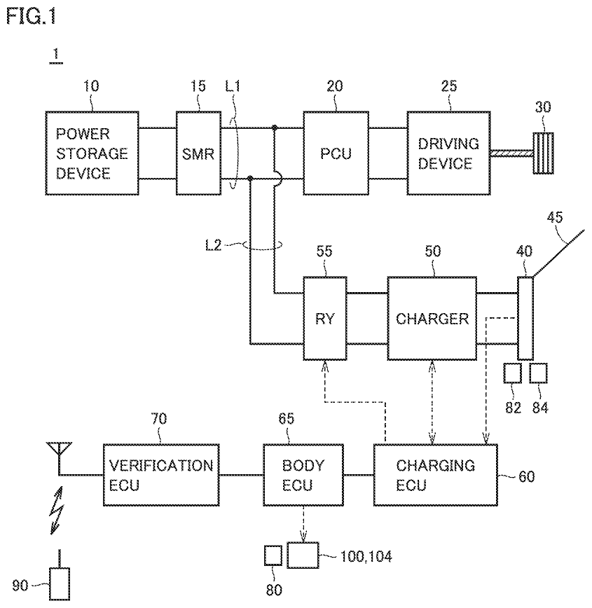

FIG. 1 is a diagram schematically showing an entire configuration example of a vehicle according to the first embodiment of the present disclosure. Referring to FIG. 1, a vehicle 1 includes a power storage device 10, a system main relay (SMR) 15, a power control unit (PCU) 20, a driving device 25, and a driving wheel 30. Vehicle 1 is an electric vehicle that uses the electric power stored in power storage device 10 to cause driving, device 25 to drive driving wheel 30. Vehicle 1 may be a hybrid vehicle further including an engine, or may be a fuel cell vehicle further including a fuel cell as a power supply in addition to power storage device 10, and the like.

Power storage device 10 is a chargeable and dischargeable electric power storage component. Power storage device 10 is configured to include, for example, a secondary battery such as a lithium-ion battery or a nickel-metal hydride battery, or a power storage element such as an electric double layer capacitor. A lithium-ion secondary battery is a secondary battery containing; lithium as a charge carrier, and may also include a common lithium ion secondary battery including a liquid electrolyte, or a so-called all-solid-state battery including a solid electrolyte.

SMR 15 is provided between power storage device 10 and a power line L1 and serves as a relay for electrical connection/disconnection between power storage device 10 and power line L1. PCU 20 is a collective term for power conversion devices that receive electric power from power storage device 10 to drive driving device 25. For example, PCU 20 includes: an inverter that drives a motor included in driving device 25; a converter that raises the voltage of the electric power output from power storage device 10; and the like.

Driving device 25 is a collective term for devices for driving the driving wheel 30. For example, driving device 25 includes a motor, an engine and the like for driving the driving wheel 30. Driving device 25 generates electric power, for example, during braking of the vehicle by the motor that drives driving wheel 30. Then, driving device 25 outputs the generated electric power to PCU 20.

Vehicle 1 further includes a power receiving port unit 40, a lid 45, a charger 50, and a charging relay 55. In the same manner as with a conventional oil inlet port, power receiving port unit 40 is formed in a recess portion provided on the external surface of the vehicle. Power receiving port unit 40 is provided with an inlet (not shown) to which a connector of a charging cable connected to a charging facility can be attached. Lid 45 serves as a cover of power receiving port unit 40 and is provided in power receiving port unit 40 by a joint such as a hinge such that lid 45 can be opened and closed.

Power receiving port unit 40 outputs, to a charging ECU 60 (described later), a connector connection signal showing whether the connector of the charging cable is connected to the inlet or not. When the connector is connected to the inlet, the connector connection signal is activated. Also, power receiving port unit 40 outputs, to charging ECU 60, a lid signal showing whether lid 45 is opened or closed. When lid 45 is closed, the lid signal is activated.

Power receiving port unit 40 further includes a lid lock device 82 and a connector lock device 84. Lid lock device 82 is configured to switch closed lid 45 between a locked state and an unlocked state. Connector lock device 84 is configured to switch connection of the connector of the charging cable to the inlet (not shown) between a locked state and an unlocked state. The configurations of power receiving port unit 40, lid lock device 82, and a connector lock device 84 will be described later in detail.

In the state where the connector of the charging facility is connected to the inlet of power receiving port unit 40, charger 50 converts the electric power supplied from the charging facility into a voltage level of power storage device 10, and then, outputs the converted electric power. Charger 50 is configured, for example, to include a power factor correction (PFC) circuit, an inverter, an insulation transformer, a rectifier circuit, and the like. Charging relay 55 serves as a relay for electrical connection/disconnection between charger 50 and a power line L2 that is connected to power line L1.

Vehicle 1 further includes a charging ECU (electronic control unit) 60, body ECU 65, a verification ECU 70, a lock relay 100, an unlock relay 104, and a door lock device 80.

Each of charging ECU 60, body ECU 65 and verification ECU 70 is configured to include a central processing unit (CPU), memories (a random access memory (RAM) and a read only memory (ROM)), and an interface (I/F) device through which various signals are input and output (each of the elements is not shown). The CPU develops the program, which is stored in the ROM, on the RAM for execution. The program stored in the ROM includes a description of a process to be performed by the CPU. Charging ECU 60, body ECU 65, and verification ECU 70 are connected through a vehicle-mounted network such as a controller area network (CAN) so as to be capable of exchanging information with one another.

From power receiving port unit 40, charging ECU 60 receives: a lid signal showing whether lid 45 is opened or closed; and a connector connection signal showing whether the connector of the charging facility is connected to the inlet or not. Furthermore, when the connector is connected to the inlet and a prescribed preparation process for performing external charging is completed, charging ECU 60 turns on charging relay 55. Then, charging ECU 60 performs a prescribed computing process based on the signals from various sensors and the information stored in the memories. Based on the computed result, charging ECU 60 controls charger 50 to perform external charging.

Verification ECU 70 wirelessly communicates with a portable terminal 90 carried by a user to perform control for permitting door lock device 80 to lock and unlock a door for vehicle occupant (not shown). Specifically, when verification ECU 70 detects a door lock operation by the user while vehicle I is stopped, verification ECU 70 performs ID verification of portable terminal 90. Examples of the door lock operation include: an operation in which a user operates a door lock switch provided in portable terminal 90; and an operation in which a user touches a door lock sensor provided in a door handle.

Then, when ID verification of portable terminal 90 succeeds, verification ECU 70 outputs a door lock command to body ECU 65. Furthermore, also when verification ECU 70 detects a door unlock operation by the user, verification ECU 70 performs ID verification of portable terminal 90. When ID verification succeeds, verification ECU 70 outputs a door unlock command to body ECU 65.

Body ECU 65 controls door lock device 80 based on the door lock command or the door unlock command received from verification ECU 70. Door lock device 80 is configured to switch the closed door for vehicle occupant between a locked state and an unlocked state. Lock relay 100 serves as a relay that switches supply and interruption of the operating power for operating door lock device 80 to bring the door for vehicle occupant into a locked state. Unlock relay 104 serves as a relay that switches supply and interruption of the operating power for operating door lock device 80 to bring the door for vehicle occupant into an unlocked state.

Upon reception of a door lock command from verification ECU 70, body ECU 65 turns on lock relay 100. Thereby, door lock device 80 is operated to bring the door for vehicle occupant into a locked state. Also, upon reception of a door unlock command from verification ECU 70, body ECU 65 turns on unlock relay 104. Thereby, door lock device 80 is operated to bring the door for vehicle occupant into an unlocked state.

As will be described later in detail, in the present embodiment, lid lock device 82 and connector lock device 84 are configured to operate in cooperation with door lock device 80. Specifically, when body ECU 65 controls door lock device 80 to bring the door for vehicle occupant into a locked state, lid lock device 82 also operates to bring lid 45 into a locked state, and connector lock device 84 also operates to bring the connection between the inlet and the connector into a locked state. Furthermore, when body ECU 65 controls door lock device 80 to bring the door for vehicle occupant into an unlocked state, lid lock device 82 also operates to bring lid 45 into an unlocked state, and connector lock device 84 also operates to bring the connection between the inlet and the connector into an unlocked state.

In the above description, the control units are configured separately as charging ECU 60, body ECU 65, and verification ECU 70, but two or all of charging ECU 60, body ECU 65, and verification ECU 70 may be configured as one ECU.

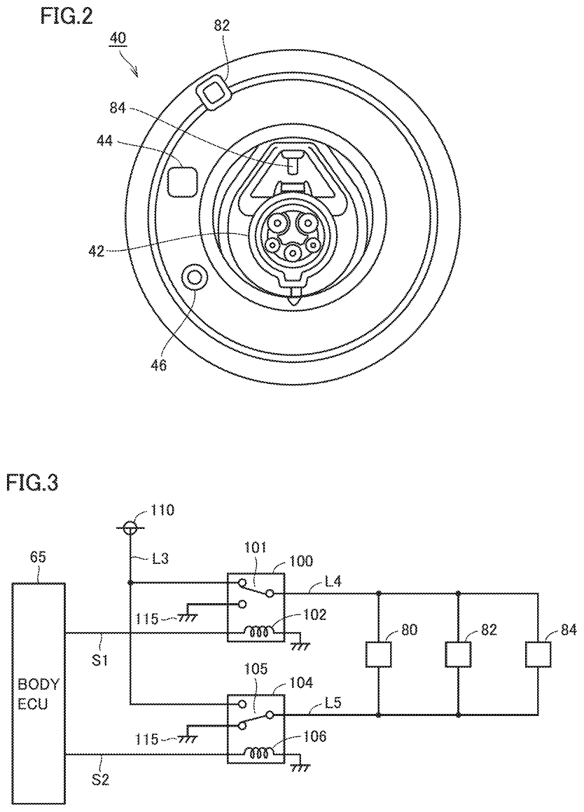

FIG. 2 is a diagram showing a configuration example of power receiving port unit 40 shown in FIG. 1. FIG. 2 does not show lid 45. Referring to FIG. 2, power receiving port unit 40 includes an inlet 42, a charge indicator 44, a lid switch 46, lid lock device 82, and connector lock device 84.

Inlet 42 is configured such that a connector (not shown) of the charging cable is connectable thereto. When the connector is connected to inlet 42, a connector connection signal that is output to charging ECU 60 is activated. Charge indicator 44 is turned on during execution of external charging. Lid switch 46 is configured to be detectable whether lid 45 (not shown) is opened or closed. When lid switch 46 is pushed down by closing of lid 45, the lid signal that is output to charging ECU 60 is activated.

Lid lock device 82 is configured, for example, to include a lock pin that can be moved forward and backward, and a driving device that drives the lock pin. When the lock pin is moved forward, lid lock device 82 brings about a locked state in which lid 45 cannot be opened. When the lock pin is moved backward, lid lock device 82 brings about an unlocked state in which lid 45 can be opened. Lid lock device 82 can be operated irrespective of whether lid 45 is opened or closed. Thus, lid lock device 82 can be operated also when lid 45 is opened.

Connector lock device 84 is provided in the vicinity of the outer circumference of inlet 42. Connector lock device 84 is configured, for example, to include a lock pin that can be moved forward and backward, and a driving device that drives the lock pin. When the lock pin is moved forward, connector lock device 84 bring about a locked state in which the connector of the charging cable connected to inlet 42 cannot be removed from inlet 42. When the lock pin is moved backward, connector lock device 84 brings about an unlocked state in which the connector can be removed from inlet 42. Connector lock device 84 can be operated irrespective of whether the connector is connected to inlet 42 or not. Thus, connector lock device 84 can be operated also when the connector is not connected to inlet 42.

FIG. 3 is a diagram showing a configuration example of a circuit for operating door lock device 80, lid lock device 82, and connector lock device 84. Referring to FIG. 3, lock relay 100 includes a contact point 101 and a coil 102. When coil 102 is energized, contact point 101 operates to connect a power line L4 to a power supply node 110 through power line L3. When coil 102 is not energized, contact point 101 operates to connect power line L4 to a body earth 115. Coil 102 is connected to body ECU 65 through a signal line SI and switched by body ECU 65 between an energized state and a non-energized state. In the following description, the state where power line L4 is connected to power supply node 110 will be described as “lock relay 100 is turned on”, and the state where power line L4 is connected to body earth 115 will be described as “lock relay 100 is turned off”.

Unlock relay 104 includes a contact point 105 and a coil 106. When coil 106 is energized, contact point 105 operates to connect a power line L5 to power supply node 110 through power line L3. When coil 106 is not energized, contact point 105 operates to connect power line L5 to body earth 115. Coil 106 is connected to body ECU 65 through a signal line S2 and switched by body ECU 65 between an energized state and a non-energized state. In the following description, the state where power line L5 is connected to power supply node 110 will be described as “unlock relay 104 is turned on”, and the state where power line L5 is connected to body earth 115 will be described as “unlock relay 104 is turned off”.

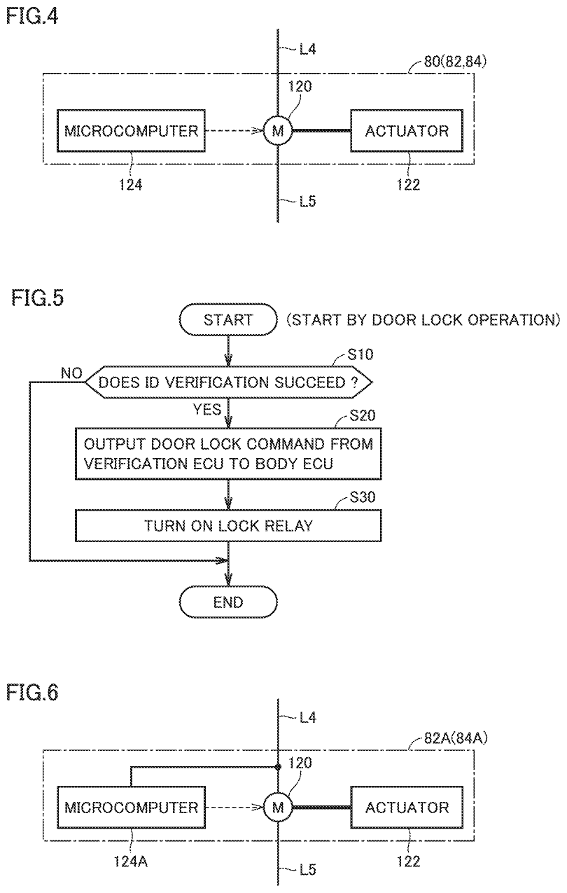

Door lock device 80 is connected between power line L4 and power line L5. FIG. 4 is a diagram schematically showing a configuration example of door lock device 80. Referring to FIG. 4, door lock device 80 includes a motor 120, an actuator 122, and a microcomputer 124. Motor 120 is connected between power line L4 and power line L5. When a current (a lock current) flows from power line L4 through motor 120 into power line L5, motor 120 rotates in a forward direction. When a current (an unlock current) flows from power line L5 through motor 120 into power line L4, motor 120 rotates in a reverse direction.

Actuator 122 is driven by motor 120. Actuator 122 is configured to bring the door into a locked state in response to forward rotation of motor 120, and bring the door into an unlocked state in response to reverse rotation of motor 120.

Microcomputer 124 is configured to include a CPU, a memory, and an input/output I/F device, and controls the operation of motor 120.

Again referring to FIG. 3, upon reception of a door lock command from verification ECU 70 (FIG. 1), body ECU 65 energizes coil 102 of lock relay 100 through signal line S1 (coil 106 of unlock relay 104 is not energized). Thus, power line L4 is connected to power supply node 110 (power line L5 is connected to body earth 115), so that a lock current is supplied to door lock device 80. Thereby, motor 120 of door lock device 80 (which may be hereinafter referred to as a “door lock motor”) rotates in a forward direction. Then, door lock device 80 locks the door.

On the other hand, upon reception of a door unlock command from verification ECU 70, body ECU 65 energizes coil 106 of unlock relay 104 through signal line S2 (coil 102 of lock relay 100 is not energized). Thus, power line L5 is connected to power supply node 110 (power line L4 is connected to body earth 115), so that an unlock current is supplied to door lock device 80. Thereby, the door lock motor rotates in a reverse direction, thereby unlocking the door.

As shown in the figure, in vehicle 1 according to the present first embodiment, lid lock device 82 is connected between power line L4 and power line L5 as with door lock device 80. Furthermore, connector lock device 84 is also connected between power line L4 and power line L5 as with door lock device 80 and lid lock device 82.

The schematic configuration of each of lid lock device 82 and connector lock device 84 is the same as the configuration shown in FIG. 4. Specifically, again referring to FIG. 4, each of lid lock device 82 and connector lock device 84 also includes a motor 120, an actuator 122, and a microcomputer 124. Also in each of lid lock device 82 and connector lock device 84, when a current (a lock current) flows from power line L4 through motor 120 into power line L5, motor 120 rotates in a forward direction. When a current (an unlock current) flows from power line L5 through motor 120 into power line L4, motor 120 rotates in a reverse direction. In the following description, motor 120 of lid lock device 82 may also be referred to as a “lid lock motor” while motor 120 of connector lock device 84 may also be referred to as a “connector lock motor”.

Furthermore, in the case of lid lock device 82, when the lid lock motor rotates in a forward direction, actuator 12.2 moves the lock pin forward to bring lid 45 into a locked state Also, when the lid lock motor rotates in a reverse direction, actuator 122 moves the lock pin backward to bring lid 45 into an unlocked state.

Furthermore, in the case of connector lock device 84, when the connector lock motor rotates in a forward direction, actuator 122 moves the lock pin forward to lock the connection between inlet 42 and the connector of the charging cable. Also, when the connector lock motor rotates in a reverse direction, actuator 122 moves the Jock pin backward to unlock the connection such that the connector can be removed from inlet 42.

Again referring to FIG. 3, in vehicle 1 according to the present first embodiment, lid lock device 82 receives, through the same lock relay 100 as that for door lock device 80, the electric power for operating lid lock device 82 to bring lid 45 into a locked slate. Connector lock device 84 also receives, through lock relay 100, the electric power for operating connector lock device 84 to bring the connection between inlet 42 and the connector into a locked state.

Also on the unlock operation side, lid lock device 82 receives, through the same unlock relay 104 as that for door lock device 80, the electric power for operating lid lock device 82 to bring lid 45 into an unlocked state. Furthermore, connector lock device 84 also receives, through unlock relay 104, the electric power for operating connector lock device 84 to bring the connection between inlet 42 and the connector into an unlocked state.

By the configuration as described above, lid lock device 82 and connector lock device 84 can be operated in cooperation with door lock device 80. In addition, the same relay can be used for switching supply and interruption of the operating power to each of door lock device 80, lid lock device 82, and connector lock device 84. Thus, door lock device 80, lid lock device 82, and connector lock device 84 do not have to include their respective relays for switching supply and interruption of the operating power, so that a circuit can be formed inexpensively.

FIG. 5 is a flowchart illustrating an example of the procedure of a process performed in response to a user's door lock operation. Referring to FIG. 5, when the user performs a door lock operation while vehicle 1 is stopped, verification ECU 70 performs ID verification of portable terminal 90 carried by the user (step S10). Then, when ID verification succeeds (YES in step S10), verification ECU 70 permits locking of the door for vehicle occupant, and outputs a door lock command to body ECU 65 (step S20).

Upon reception of the door lock command from verification ECU 70, body ECU 65 energizes coil 102 of lock relay 100 to thereby turn on lock relay 100 (step S30). Although not specifically shown, coil 106 of unlock relay 104 is not energized and unlock relay 104 is off. Thereby, a lock current flows through the door lock motor while a lock current flows also through the lid lock motor and the connector lock motor, with the result that the door is locked. Also, in cooperation with this locking of the door, lid 45 is locked when lid 45 is closed, and the connection between the connector of the charging cable and inlet 42 is locked when the connector is connected to inlet 42.

In the present first embodiment, lid lock device 82 and connector lock device 84 operate in cooperation with door lock device 80. When the connector is connected to inlet 42, lid 45 is opened. When the door lock operation is performed in this state, locking of the connector and operation of lid lock device 82 are performed in cooperation with locking of the door, which however does not cause any particular functional problem. Furthermore, when lid 45 is closed, the connector is not connected to inlet 42. When the door lock operation is performed in this state, locking of the lid and operation of connector lock device 84 are performed in cooperation with locking of the door, which however does not cause any particular functional problem.

As described above, according to the present first embodiment, lid lock device 82 and connector lock device 84 can be operated in cooperation with door lock device 80. Also, lock relay 100 and unlock relay 104 can be used in common for switching supply and interruption of the operating power to each of the lock devices. Thus, according to the present first embodiment, each of the lock devices does not have to include a lock relay and an unlock relay, so that a circuit for operating each lock device can be formed inexpensively.

### Second Embodiment

When the lid lock device and the connector lock device operate simultaneously with the door lock device in response to the user's door lock operation, the operation noises of the lid lock device and the connector lock device are masked by the operation noise of the door lock device. This may prevent a user from recognizing that the lid lock device or the connector lock device has operated.

Thus, in the present second embodiment, when lock relay 100 is turned on in response to the user's door lock operation, the lid lock device and the connector lock device are operated behind the door lock device. This prevents the operation noise of the lid lock device or the connector lock device from being masked by the operation noise of the door lock device, thereby allowing the user to recognize that the lid lock device or the connector lock device has operated.

The entire configuration of the vehicle in the present second embodiment is the same as the configuration shown in FIG. 1. Also, in the present second embodiment, the configuration of the circuit for operating the door lock device, the lid lock device, and the connector lock device is the same as the configuration shown in FIG. 3. Furthermore, the operations of the lid lock device and the connector lock device are delayed from the operation of the door lock device.

FIG. 6 is a diagram schematically showing a configuration example of a lid lock device 82A in the second embodiment. Referring to FIG. 6, lid lock device 82A has the configuration shown in FIG. 4 and including a microcomputer 124A in place of microcomputer 124.

Microcomputer 124A controls motor 120 (lid lock motor) to rotate/stop. The rotation direction of motor 120 is determined by the direction of the current (lock current/unlock current) that flows through motor 120. Microcomputer 124A is connected to power line L4 and, for example, senses the voltage on power line L4 to thereby detect whether lock relay 100 has been turned on or not. Then, when microcomputer 124A detects that lock relay 100 has been turned on, microcomputer 124A outputs an operation command to motor 120 after a lapse of a prescribed time period At since this detection.

It should be noted that the schematic configuration of connector lock device 84A in the second embodiment is the same as that of the above-mentioned lid lock device 82A.

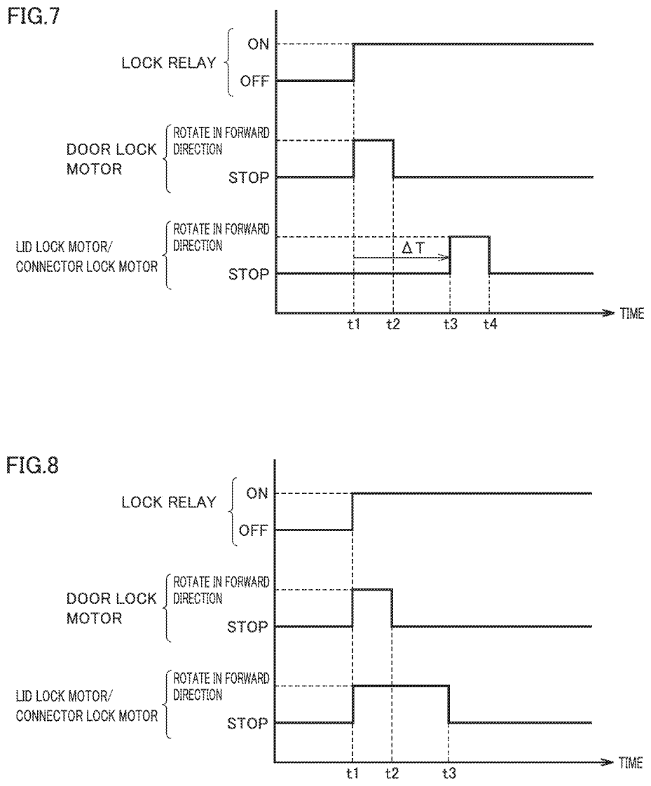

FIG. 7 is a diagram showing timings at which door lock device 80, lid lock device 82A, and connector lock device 84A in the second embodiment are operated. Referring to FIG. 7, when lock relay 100 is turned on at time 11 in response to the user's door lock operation, the door lock motor rotates in a forward direction and door lock device 80 locks the door.

When lock relay 100 is turned on and then prescribed time period Δt has elapsed, the lid lock motor and the connector lock motor each rotate in a forward direction. In other words, when lock relay 100 is turned on, the lid lock motor and the connector lock motor operate behind the door lock motor by prescribed time period Δt.

If prescribed time period At is too short, the operation noises of lid lock device 82A and connector lock device 84A cannot be distinguished from the operation noise of door lock device 80. If prescribed time period At is too long, the user located away from the vehicle cannot recognize the operation noises of lid lock device 82A and connector lock device 84A. Thus, in some embodiments, in consideration of the operation time of door lock device 80, prescribed time period At is 200 milliseconds or more and also 5 seconds or less.

In the above description, when door lock device 80 is operated in response to the user's door lock operation, lid lock device 82A and connector lock device 84A each are operated behind door lock device 80. However, only one of lid lock device 82A and connector lock device 84A may be operated behind door lock device 80.

According to the present second embodiment, at least one of lid lock device 82A and connector lock device 84A operates behind door lock device 80 by prescribed time period Δt, which allows the user to recognize that lid lock device 82A and/or connector lock device 84A have/has operated.

[Modifications]

Instead of delaying the operations of the lid lock device and the connector lock device from the operation of the door lock device, the lid lock device and the connector lock device may be operated longer in time than the door lock device. This also allows the user to recognize that the lid lock device and/or the connector lock device have/has operated.

Again referring to FIG. 6, also in the present modification, the operation times of lid lock device 82 and connector lock device 84 with respect to the operation time of door lock device 80 are adjusted by microcomputers 124 of lid lock device 82 and connector lock device 84, respectively.

In other words, microcomputer 124 of lid lock device 82 controls the rotation of the lid lock motor such that the operation time of the lid lock motor is longer than the operation time of the door lock motor in door lock device 80. Also in connector lock device 84, similarly, microcomputer 124 of connector lock device 84 controls the rotation of the connector lock motor such that the operation time of the connector lock motor is longer than the operation time of the door lock motor in door lock device 80.

FIG. 8 is a diagram showing timings at which door lock device 80, lid lock device 82, and connector lock device 84 in the present modification are operated. Referring to FIG. 8, when lock relay 100 is turned on at time t1 in response to the user's door lock operation, the door lock motor rotates in a forward direction, and door lock device 80 locks the door. The door lock motor starts rotating in a forward direction at time t1, and then, stops at time t2.

When lock relay 100 is turned on at time t1, the lid lock motor and the connector lock motor each also rotate in a forward direction. Thereby, when lid 45 is closed, lid 45 is locked. Also, when the connector is attached to inlet 42, the connection between inlet 42 and the connector is locked. Then, the lid lock motor and the connector lock motor each start rotating in a forward direction at time t1, and then, stop at time t3. From time t2 to time t3, the door lock motor has already stopped, so that the user can recognize the operation noises of lid lock device 82 and connector lock device 84.

In the above description, when door lock device 80 operates in response to the user's door lock operation, the operation time of each of lid lock device 82 and connector lock device 84 is set to be longer than the operation time of door lock device 80. However, the operation time of only one of lid lock device 82 and connector lock device 84 may be set to be longer than the operation time of door lock device 80.

In the present modification, there occurs a situation where only at least one of lid lock device 82 and connector lock device 84 operates, which allows the user to recognize that lid lock device 82 and/or connector lock device 84 haeve/has operated,

### Third Embodiment

In the present third, embodiment, a noise generator for generating a noise during the operations of the lid lock device and the connector lock device is provided in order to allow the user to recognize the operation noises of the lid lock device and the connector lock device,

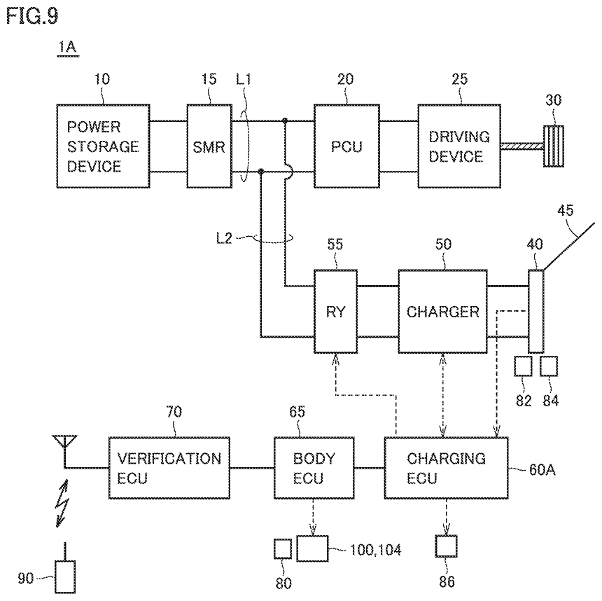

FIG. 9 is a diagram schematically showing an entire configuration example of a vehicle according to the third embodiment Referring to FIG. 9, a vehicle 1A has the configuration of vehicle 1 shown in FIG. 1 and additionally including: a noise generator 86; and a charging ECU 60A in place of charging ECU 60.

According to an instruction from charging ECU 60A, noise generator 86 generates a noise while lid lock device 82 and connector lock device 84 are operated. Noise generator 86 generates a noise that is distinguishable from the operation noise of locking of the door and is constituted, for example, by a speaker, a buzzer, a siren, or the like. When a noise generator for generating a noise in association with locking of the door is separately provided, noise generator 86 generates a noise (a frequency, a tone, a level and the like) that is distinguishable from the noise generated by the noise generator for generating a noise in association with locking of the door.

Charging ECU 60.A receives a lock relay ON signal from body ECU 65. In the present third embodiment, upon reception of a door lock command from verification ECU 70, body ECU 65 turns on lock relay 100. Then, body ECU 65 outputs, to charging ECU 60A, the above-mentioned lock relay ON signal showing that lock relay 100 has been turned on. Then, upon reception of the lock relay ON signal from body ECU 65, charging ECU 60A outputs a noise generation command to noise generator 86.

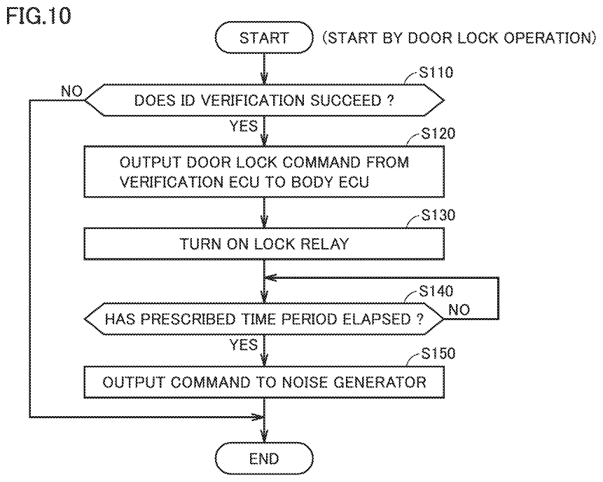

FIG. 10 is a flowchart illustrating an example of the procedure of a process performed in response to a user's door lock operation in the third embodiment. Referring to FIG. 10, the processes in step S110 to step S130 are the same as those in steps S10 to S30 of the flowchart shown in FIG. 5. Then, when lock relay 100 is turned on in step S130 and charging ECU 60A receives a lock relay ON signal from body ECU 65, and after a lapse of a prescribed time period (YES in step S140), charging ECU 60A outputs a command to noise generator 86 to generate a noise (step S150).

It should be noted that step S140 is a process provided for displacing the operation timings of door lock device 80 and noise generator 86 from each other. Thus, even when the operation noise of door lock device 80 overlaps with the noise generated by noise generator 86, but when the user can recognize the noise of noise generator 86, step S140 can also be omitted.

As described above, according to the present third embodiment, noise generator 86 allows the user to recognize that lid lock device 82 and connector lock device 84 have operated.

### Fourth Embodiment

In each of the above-described embodiments, each of lid lock device 82 (82A) and connector lock device 84 (84A) operates in cooperation with door lock device 80. In the present fourth embodiment, when the connector of the charging cable is connected to inlet 42, lid 45 is opened. Accordingly, only connector jock device 84 (84A) is operated in cooperation with door lock device 80, but lid lock device 82 (82A) is not operated. On the other hand, when lid 45 is closed and the connector is not connected to inlet. 42, only lid lock device 82 (82A) is operated in cooperation with door lock device 80, but connector lock device 84 (84A) is not operated. Thereby, power consumption by an unnecessary lock operation can be prevented.

The vehicle according to the present fourth embodiment has the configuration of vehicle 1 shown in FIG. 1 and including: a charging ECU 60B in place of charging ECU 60; and a lid lock device 82B and a connector lock device 84B in place of lid lock device 82 and connector lock device 84, respectively.

FIG. 11 is a diagram showing a configuration example of a circuit for operating door lock device 80, lid lock device 82B, and connector lock device 84B in the fourth embodiment. Referring to FIG. 11, each of lid lock device 82B and connector lock device 84B is configured to be capable of receiving a signal from charging ECU 60B.

When the connector is connected to inlet 42, charging ECU 60B outputs a command to lid lock device 82B for instructing lid lock device 82B not to operate. On the other hand, when lid 45 is closed and the connector is not connected to inlet 42, charging ECU 60B outputs a command to connector lock device 84B for instructing connector lock device 84B not to operate.

Lid lock device 82B is configured to be capable of switching lid 45 between a locked state and an unlocked state. Also, in the case where lid lock device 82B receives a non-operation command from charging ECU 60B, lid lock device 82B does not operate even when lock relay 100 is turned on.

Connector lock device 84B is configured to be capable of switching the connection of the connector to inlet 42 between a locked state and an unlocked state. Also, in the case where connector lock device 84B receives a non-operation command from charging ECU 60B, connector lock device 84B does not operate even when lock relay 100 is turned on.

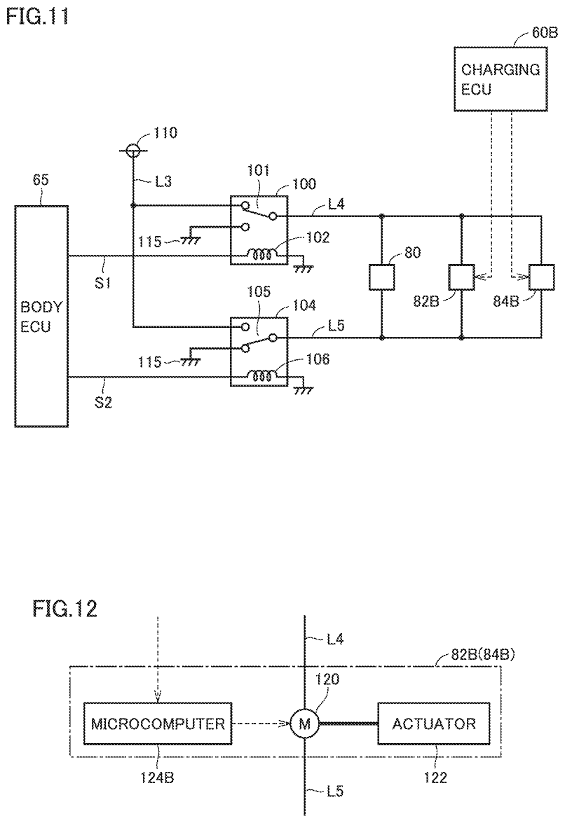

FIG. 12 is a diagram schematically showing a configuration example of lid lock device 82B in the fourth embodiment. Referring to FIG. 12, lid lock device 82B has the configuration shown in FIG. 4 and including a microcomputer 124B in place of microcomputer 124.

Microcomputer 124B controls motor 120 (lid lock motor) to rotate/stop. The rotation direction of motor 120 is determined by the direction of the current (lock current/unlock current) that flows through motor 120. Microcomputer 124B is configured to be capable of receiving a command from charging ECU 60B. Upon reception of a non-operation command from charging ECU 60B, microcomputer 124B controls the lid lock motor to be stopped.

The schematic configuration of connector lock device 84B is the same as that of the above-described lid lock device 82B. In other words, microcomputer 124B of connector lock device 84B is also configured to be capable of receiving a command from charging ECU 60B. Upon reception of a non-operation command from charging ECU 60B, microcomputer 124B controls the connector lock motor to be stopped.

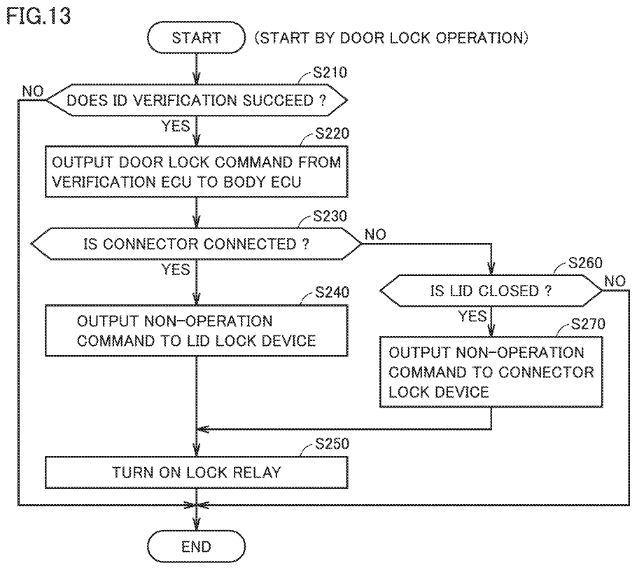

FIG. 13 is a flowchart illustrating an example of the procedure of a process performed in response to a user's door lock operation in the fourth embodiment. Referring to FIG. 13, the processes in steps S210 and S220 arc the same as those in steps S10 and S20, respectively, of the flowchart shown in FIG. 5. When verification ECU 70 outputs a door lock command to body ECU 65 in step S220, charging ECU 60B determines whether the connector of the charging cable is connected to inlet 42 or not (step S230). Based on the connector connection signal received from power receiving port unit 40, it is determined whether the connector is connected to inlet 42 or not.

When it is determined in step S230 that the connector is connected to inlet 42 (YES in step S230), charging ECU 60B outputs a non-operation command to lid lock device 82B (step S240). When the connector is connected to inlet 42, lid 45 is opened, which eliminates the need to operate lid lock device 82B. Thus, unnecessary power consumption by the operation of lid lock device 82B is reduced.

Then, when the non-operation command is output to lid lock device 82B, body ECU 65 energizes coil 102 of lock relay 100 to turn on lock relay 100 (step S250). Thus, door lock device 80 locks the door, and only connector lock device 84B operates in cooperation with door lock device 80, thereby locking the connection between inlet 42 and the connector.

On the other hand, when it is determined in step S230 that the connector is not connected to inlet 42 (NO in step S230), charging ECU 60B determines whether lid 45 is closed or not (step S260). Based on the signal received from lid switch 46 of power receiving port unit 40, it is determined whether lid 45 is closed or not.

When it is determined in step S260 that lid 45 is closed (YES in step S260), charging ECU 60B outputs a non-operation command to connector lock device 84B (step S270). When lid 45 is closed, the connector is not connected to inlet 42, which eliminates the need to operate connector lock device 84B. Thus, unnecessary power consumption by the operation of connector lock device 84B is reduced.

Then, when the non-operation command is output to connector lock device 84B, the process proceeds to step S250, in which body ECU 65 turns on lock relay 100. Thereby, door lock device 80 locks the door, and only lid lock device 82B operates in cooperation with door lock device 80, so that lid 45 is locked.

When it is determined in step S260 that lid 45 is opened (NO in step S260), lock relay 100 is not turned on, but the process proceeds to END. In this case, lid 45 is opened despite that the connector is not connected to inlet 42. Thus, an alarm may be output to a user.

As described above, according to the present fourth embodiment, lid lock device 82B is not operated when the connector is connected to inlet 42. Thus, unnecessary consumption of electric power in lid lock device 82B can be prevented. Also, connector lock device 84B is not operated when lid 45 is closed. Thus, unnecessary consumption of electric power in connector lock device 84B can be prevented.

Also, in a combination of the above-described fourth embodiment with the second embodiment or its modification, when only one of the lid lock device and the connector lock device is operated in cooperation with the door lock device, only one of the lid lock device and the connector lock device may be operated behind the door lock device, or the operation time of only one of the lid lock device and the connector lock device may be set to be longer than the operation time of the door lock device.

Also, in a combination of the above-described fourth embodiment with the third embodiment, when only one of the lid lock device and the connector lock device is operated in cooperation with the door lock device, noise generator 86 may generate a noise in accordance with the operation of only one of the lid lock device and the connector lock device.

The embodiments disclosed herein are also intended to be combined as appropriate for implementation unless technically contradicted. It should be construed that the embodiments disclosed herein are illustrative and non-restrictive in every respect. The scope of the present disclosure is defined by the terms of the claims, rather than the description above, and is intended to include any modifications within the meaning and scope equivalent to the terms of the claims.

1. A vehicle that allows execution of external charging for charging a power storage device mounted in the vehicle by a charging facility provided external to the vehicle, the vehicle comprising:
a power receiving inlet, to which a connector of the charging facility is connectable for the external charging;
a lid provided at the power receiving inlet;
a door lock device that switches a door for vehicle occupant between a locked state and an unlocked state;
a lid lock device that switches the lid between a locked state and an unlocked state;
a connector lock device that switches connection of the connector to the power receiving inlet between a locked state and an unlocked state; and
a relay that switches supply and interruption of operating power for operating the door lock device to bring the door for vehicle occupant into the locked state, wherein
the lid lock device receives, through the relay, operating power for operating the lid lock device to bring the lid into the locked state, and
the connector lock device receives, through the relay, operating power for operating the connector lock device to bring the connection into the locked state.

2. The vehicle according to claim 1, wherein
when the relay is switched to be conductive, at least one of the lid lock device and the connector lock device operates behind the door lock device by a prescribed time period.

3. The vehicle according to claims 1, wherein
when the relay is switched to be conductive, at least one of the lid lock device and the connector look device operates longer in time than the door lock device.

4. The vehicle according to claim 1, further comprising a noise generator that generates a noise in accordance with an operation of at least one of the lid lock device and the connector lock device.

5. The vehicle according to claim 1, further comprising a controller that outputs a non-operation command to the lid lock device when the connector is connected to the power receiving inlet.

6. The vehicle according to claim 1, farther comprising a controller that outputs a non-operation command to the connector lock device when the lids closed.
